(19) United States
(12) Patent Application Publication
(10) Pub. No.: US 2012/0065337 A1
(43) Pub. Date: Mar. 15, 2012

(54) POLYMER FINE PARTICLE FOR SUPPRESSING GENERATION OF DIE BUILD-UP DURING EXTRUSION MOLDING

(75) Inventors: Toshikatsu Shoko, Kanagawa (JP); Yasou Togami, Tokyo (JP); Yasuyuki Shinpo, Kanagawa (JP)

(73) Assignee: JX NIPPON OIL & ENERGY CORPORATION, Tokyo (JP)

(21) Appl. No.: 13/319,881

(22) PCT Filed: May 24, 2010
(86) PCT No.: PCT/JP2010/059164

§ 371 Date: Nov. 10, 2011

(30) Foreign Application Priority Data
May 26, 2009 (JP) 2009-126532

(51) Int. Cl. C08L 33/12; C08F 122/10

(52) U.S. Cl. 525/308; 526/329.7

(57) ABSTRACT

During the manufacture of a master batch for a polyolefin resin film, organic polymer fine particles which contain a polyfunctional monomer (cross-linking agent) having at least one kind of two or more functional groups in a monomer unit constituting a polymer and is mixed with a polyolefin resin using an extruder are blended as an anti-blocking agent, thereby preventing the generation of die build-up around the outlet of the extruder.

### TECHNICAL FIELD

The present invention relates to a polymer fine particle for an anti-blocking agent, a master batch using the same, and a polyolefin resin film obtained by molding using the master batch. More particularly, the present invention relates to a polymer fine particle capable of preventing the generation of die build-up around an outlet of an extruder during the manufacture of a master batch using the polymer fine particles as an anti-blocking agent, an anti-blocking agent master batch suitable for a polyolefin resin film, and a polyolefin resin film using the same.

### BACKGROUND ART

A polyolefin resin film is widely used for various packaging materials because it is superior in transparency and mechanical properties. However, when the polyolefin resin films overlap with each other, they are mutually adhered, or so-called blocking phenomenon occurs. Conventionally, in order to improve the slipping property and blocking resistance of the polyolefin resin film, an anti-blocking agent (hereinafter sometimes referred to as “AB agent”) has been blended to improve the blocking resistance. A fine powdery inorganic substance as the AB agent has been blended with a polyolefin resin film. A method for blending a fine powdery polymer substance (polymer fine particles) as the AB agent has also been proposed.

In a method for industrially manufacturing a polyolefin resin film by blending an AB agent with a polyolefin resin, the blended amount of the AB agent has varied depending on the type of the polyolefin resin, the thickness of the film, the application use of the film, and difference of a molding method. In order to effectively respond to change in the blended amount of the AB agent, master batch pellets obtained by blending the AB agent in a high concentration with a polyolefin resin have been preliminarily prepared. The master batch pellets have been then blended with polyolefin resin pellets to finely adjust the blended amount of the AB agent (for example, Patent Literatures 1 and 2).

In order to manufacture a master batch, the AB agent and the polyolefin resin are mixed, the mixture is melted and kneaded with an extruder, and extruded through a die of the extruder in a strand shape, and cut into pellets. During the manufacture of an AB agent master batch, if needed, other additives such as an antioxidant, a lubricant, and an antistatic agent are appropriately blended. At this time, an agglomerate of deteriorated resin, or the like, may grow around a die outlet of the extruder. Such an agglomerate is referred to as die build-up. The generation of die build-up has problems, in which the strand may be cut when the die build-up has a certain size, and the die build-up may be transported with the strand to be mixed in product pellets. When a master batch, in which the die build-up is mixed, is blended with a polyolefin resin to manufacture a film, film defects such as a fish eye occur. Accordingly, when the die build-up is generated, an outlet of the extruder requires cleaning at certain time intervals during the manufacture of master batches. The cleaning requires the cut of the strand, and this significantly reduces productivity, and the resin must be cut at its end during the restart of operation.

This is noneconomic. In order to suppress the generation of die build-up, and improve the dispersibility of the AB agent, a method for adding other compounds such as a slipping agent has been proposed (for example, Patent Literatures 3, 4, 5, 6, and 7).

### PRIOR ART LITERATURE

Patent Literature
Patent Literature 1 Japanese Patent Application Laid-Open No. Hei. 8-225655
Patent Literature 2 Japanese Patent Application Laid-Open No. Hei. 11-106520
Patent Literature 3 Japanese Patent Application Laid-Open No. Hei. 11-12403
Patent Literature 4 Japanese Patent Application Laid-Open No. 2001-114953
Patent Literature 5 Japanese Patent Application Laid-Open No. 2002-161175
Patent Literature 6 Japanese Patent Application Laid-Open No. 2006-117816
Patent Literature 7 Japanese Patent Application Laid-Open No. 2007-91831

### DISCLOSURE OF THE INVENTION

### Problem to be Solved by the Invention

The methods described in the above Patent Literatures cannot sufficiently suppress the generation of die build-up. Moreover, if a new additive is added, the additive may affect the required physical properties of a film to be obtained more than a little. An object of the present invention is to provide an anti-blocking agent for preventing the generation of die build-up when polymer fine particles as the anti-blocking agent are blended with a polyolefin resin to manufacture a master batch, and an anti-blocking agent master batch.

### Means for Solving the Problem

In view of such a situation, the inventors of the present invention have extensively studied to suppress the generation of die build-up during extrusion molding. As a result, the inventors have found that the generation of die build-up can be suppressed using specific polymer fine particles as an anti-blocking agent, and then the present invention is completed.

That is, a first aspect of the present invention relates to an organic polymer fine particle which contains a polyfunctional monomer (cross-linking agent) having at least one kind of two or more functional groups in a monomer unit constituting a polymer, and which suppresses the generation of die build-up around an outlet of an extruder when the polymer fine particles are mixed and kneaded with a polyolefin resin using the extruder to manufacture a master batch.

A second aspect of the present invention is characterized in that the polymer fine particle is prepared by polymerizing any of an acryl-based monomer or a styrene-based monomer, or any monomer of vinyl acetate, vinyl chloride, vinylidene chloride, acrylonitrile, methacrylonitrile, or a combination of the above-described monomer or monomers and other monomer or monomers.

A third aspect of the present invention is characterized in that the polymer fine particles do not have a glass transition temperature (Tg) to be observed by differential scanning calorimetry (DSC).

A fourth aspect of the present invention relates to an anti-blocking agent master batch for polyolefin resin, in which the blended amount of the polymer fine particle described in any of the first to third aspects of the present invention is 1 to 50% by mass.

A fifth aspect of the present invention relates to a polyolefin resin film obtained by blending the anti-blocking agent master batch described in the forth aspect of the present invention with a polyolefin resin, and molding the blend.

### Effects of the Invention

According to the present invention, in the manufacture of an anti-blocking agent master batch, an effect on preventing the generation of die build-up is superior. In addition, void generation in the master batch can also be suppressed. Further, the anti-blocking agent master batch of the present invention is superior in hue. A polyolefin resin film obtained by blending this anti-blocking agent master batch with a polyolefin resin and forming a film is superior in molding processability during film forming, and is superior in transparency and surface smoothness.

### BRIEF DESCRIPTION OF DRAWINGS

FIG. 1 is an example of a DSC curve of fine particles of the present invention (Example 1).

FIG. 2 is an example of a DSC curve of conventional fine particles (Comparative Example 1).

### BEST MODE FOR CARRYING OUT THE INVENTION

### Polymer Fine Particle

The polymer fine particle of the present invention is an organic polymer fine particle, and can be obtained through general emulsification polymerization, dispersion polymerization, suspension polymerization, seed polymerization, or the like.

Examples of a monomer for use in the polymerization of such a polymer fine particle include an acryl-based monomer, a styrene-based monomer, and the like. Examples of the acryl-based monomer include acrylic acid and acrylate derivatives such as methyl acrylate, ethyl acrylate, and butyl acrylate; methacrylic acid and methacrylate derivatives such as methyl methacrylate, ethyl methacrylate, and butyl methacrylate. Examples of the styrene-based monomer include styrene and styrene derivatives such as methyl styrene, ethyl styrene, propyl styrene, and butyl styrene. In addition, examples of other monomers include polymerizable vinyl monomers such as vinyl acetate, vinyl chloride, vinylidene chloride, acrylonitrile, and methacrylonitrile.

Further, the polymer fine particles of the present invention are cross-linked to an extent sufficient to maintain its shape during the manufacture of a master batch, or in the processes such as heating, kneading, molding, and stretching during the manufacture of a film, and not to generate die build-up around the outlet of an extruder for a given time or more when the polymer fine particles are mixed with a polyolefin resin using the extruder. A cross-linking agent is a polyfunctional monomer having two or more functional groups, and is preferably a radical polymerizable monomer having two or more vinyl groups. Examples thereof include divinyl benzene, ethylene glycol diacrylate, ethylene glycol dimethacrylate, trimethylolpropane triacrylate, trimethylolpropane trimethacrylate, pentaerythritol tetraacrylate, pentaerythritol tetramethacrylate, and the like. Further, the cross-linking agent may be one kind, or two or more kinds may be used in combination.

The cross-linking agent is polymerized in a proportion of more than 15% by mass, and preferably 20 to 50% by mass with respect to the total monomer. When the proportion of the cross-linking agent is 15% by mass or less, the effect on preventing the generation of die build-up around the outlet of the extruder is insufficient.

The polymer fine particles of the present invention do not have distinct glass transition temperature (hereinafter sometimes referred to as “Tg”) to be observed by differential scanning calorimetry (DSC). In the conventional polymer fine particles (including particles having a low cross-linking agent concentration), Tg has been observed by DSC. The conventional polymer fine particles have been heated at Tg or higher in the extruder during the manufacture of a master batch or a film, and kneaded. The inventors have studied and analyzed die build-up generated around the outlet of the extruder during the manufacture of a master batch using the conventional polymer fine particles as an anti-blocking agent. As a result, the inventors have found that the die build-up is composed of polymer fine particles. From this reasons, it is assumed that, since the conventional polymer fine particles are kneaded and extruded at a temperature of Tg or higher in the extruder, the viscosity in the surface of polymer fine particle is increased, and thus the polymer fine particles adhere to a die lip around the outlet of the extruder to generate die build-up. On the other hands, the polymer fine particles of the present invention do not have distinct Tg to be observed, and the viscosity in the surface even at a temperature during the manufacture of a master batch is not so high as that of the conventional polymer fine particles.

Therefore, it is considered that adhesion of the polymer fine particles to a die lip around the outlet of an extruder can be reduced to suppress the generation of die build-up.

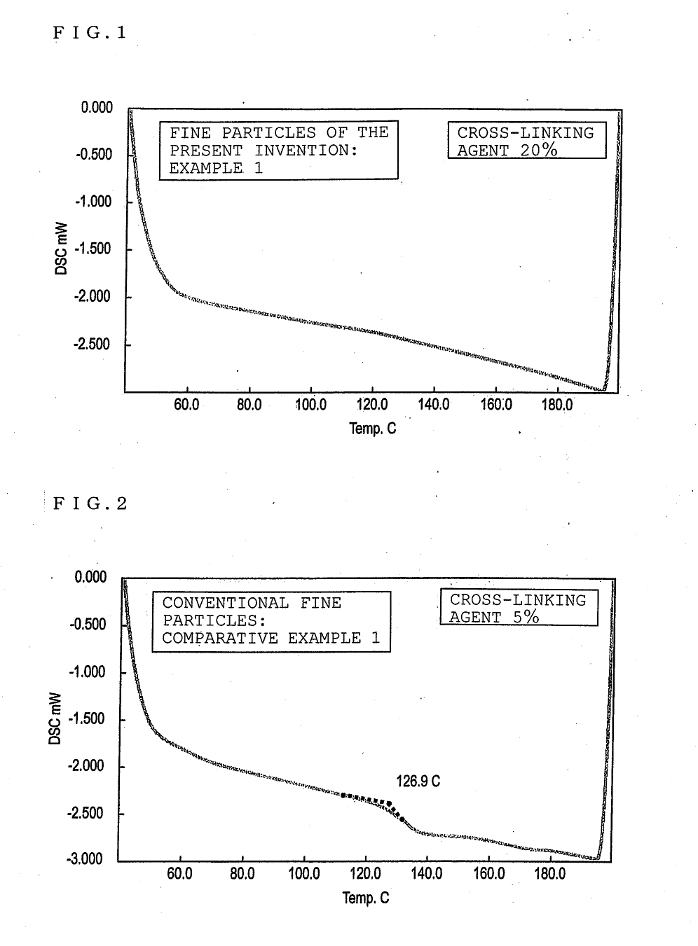

In FIG. 1, a flexion point is not found around 120° C., and Tg is not observed. In FIG. 2, Tg having a flexion point at 126.9° C. is observed.

The polymer fine particles of the present invention are mixed as an anti-blocking agent with a polyolefin resin to manufacture an anti-blocking agent master batch for polyolefin resin.

### (Polyolefin Resin)

The polyolefin resin for use in the present invention is a homopolymer or a copolymer of an olefin monomer, or a mixture thereof. The olefin monomer means ethylene and α-olefin, and examples of α-olefin include propylene, butene-1, hexene-1, 4-methylpentene-1, and octene-1.

The polyolefin resin also includes copolymers of olefin and vinyl ester, α,β-unsaturated carboxylic acid, and their derivatives.

A polyolefin resin suitable for manufacturing a film is particularly preferable as the polyolefin resin. Publicly known polyethylene resins, polypropylene resin, and the like, can be used, for example. Examples of the polyethylene resin include an ethylene homopolymer, a copolymer of ethylene and another α-olefin such as high density polyethylene, low density polyethylene, and very low density polyethylene, a copolymer of ethylene and vinyl ester, α,β-unsaturated carboxylic acid, or their derivatives, and a linear low density polyethylene resin (LLDPE) which is a copolymer of ethylene and α-olefin. Examples of the polypropylene resin include crystalline propylene homopolymers, and a copolymer of propylene and ethylene or another α-olefin.

### (Blended Amount of Polymer Fine Particle)

The blended amount of polymer fine particles in the anti-blocking agent master batch of the present invention is 1 to 50% by mass, and preferably 10 to 40% by mass with respect to the total (100% by mass) of the polyolefin resin and the polymer fine particles. When the blended amount is less than the lower limit of the range, the added amount of master batch is increased during the manufacture of product film. If a film-based resin and a master batch-based resin are different, they may affect the properties of the film more than a little. This is also inefficient from a productivity perspective. When it exceeds the upper limit, it is difficult to disperse the polymer fine particles. This may also affect the physical properties of the resulting film.

### (Method for Manufacturing Master Batch)

As a method for manufacturing the anti-blocking agent master batch of the present invention, a known method can be used as long as the method can disperse the polyolefin resin and the polymer fine particles uniformly. A preferable example thereof include a method, in which they are mixed with a ribbon blender, a Henschel Mixer, or the like, and the mixture is melted and kneaded with an extruder, and extruded into a strand shape through a die of the extruder, and the strand is cut in an appropriate length to obtain the product as pellets. In this case, if needed, known additives such as an antioxidant, an antistatic agent, and a lubricant can appropriately be blended.

### (Polyolefin Resin Film)

In the polyolefin resin film of the present invention, the above-defined polyolefin resin is blended with the above anti-blocking agent master batch so that the content of the polymer fine particles in the film is 0.01 to 2.0 parts by mass, and preferably 0.05 to 1.0 parts by mass, with respect to 100 parts by mass of the polyolefin resin. When the anti-blocking agent master batch is used for a sealant layer of multilayer film having two or more layers, the polymer fine particles are blended so that the content thereof in the film sealant layer is 0.01 to 2.0 parts by mass, and preferably 0.05 to 1.0 parts by mass, with respect to 100 parts by mass of the polyolefin resin in the sealant layer. When the content is less than the lower limit of the range, blocking resistance cannot be imparted to the product film. When it exceeds the upper limit, it may affect the physical properties of the resulting film.

The polyolefin resin film is manufactured so that the anti-blocking agent master batch of the present invention is diluted with the polyolefin resin to adjust the concentration of the anti-blocking agent in the product film to a desired concentration. A method for blending the polyolefin resin with the anti-blocking agent master batch is not specifically limited as long as a method and an apparatus can mix them uniformly. Examples of the method include a method for mixing them with a ribbon blender, a Henschel Mixer, or the like, melting and kneading the resulting mixture with an extruder, and forming a film through a publicly known method. In this case, if needed, known additives such as an antioxidant, an antistatic agent, and a lubricant can appropriately be blended.

### EXAMPLES

Hereinafter, the present invention will be specifically described by way of Examples and Comparative Examples. However, the present invention is not particularly limited to the following Examples.

### Manufacture Example 1 of Polymer Fine Particles

The following polymer fine particles were manufactured using an emulsification apparatus (see WO 2007/117041, Examples and FIGS. 1 to 4), in which 30 units each including a wire gauze including a main gauze of 324/2400 mesh and a spacer having a length of 10 mm and an inner diameter of 10 mm are inserted into a cylindrical casing having an inner diameter of 15 mm.

As reaction raw materials, methyl methacrylate (MMA), in which 1% by mass of benzoyl peroxide (initiator) and 20% by mass of ethylene glycol dimethacrylate (cross-linking agent) were dissolved, and an aqueous solution of a dispersing agent (1% by mass, PVA 217, available from KURARAY Co., Ltd.) were used. The raw materials were introduced into the emulsification apparatus using separate plunger pumps at respective flow rates of 17 ml/min and 33 ml/min and thus were subjected to emulsification to obtain an emulsion. This emulsion was heated and stirred under a nitrogen atmosphere at 90° C. for 3 hours to obtain solid MMA polymer fine particles. The polymer fine particles were dispersed in water, the volume average particle diameter of the MMA polymer fine particles measured by the following method was 10.1 μm, and the CV value was 17.7%. Further, the glass transition temperature (Tg) was not observed.

(1) Volume average particle diameter: measured using a Coulter Counter (manufactured by Beckman Coulter Inc., Multisizer II). The number of measured particles was 100,000.

(2) CV value: calculated by the following equation (1):

CV value=(Standard deviation of particle diameter distribution)/(Volume average particle diameter)×100 (1).

(3) Glass transition temperature (Tg): measured by a differential scanning calorimeter (manufactured by Seiko Instruments Inc., SSC5200) under the following conditions:

Temperature range: 40 to 200° C., and temperature-elevating speed: 10° C./min.

The same method was used to measure the volume average particle diameter, the CV value, and Tg in the following Examples and Comparative Examples.

### Manufacture Example 2 of Polymer Fine Particles

Polymer fine particles were manufactured in the same operation as in Manufacture Example 1 except that the concentration of the cross-linking agent was changed to 30% by mass. The volume average particle diameter of the polymer fine particles was 10.1 μm, and the CV value was 18.5%. Tg was not observed.

### Manufacture Example 3 of Polymer Fine Particles

The reaction raw materials having the same composition as in Manufacture Example 1 were emulsified and dispersed using a TK homomixer (manufactured Tokushu Kika Kogyo Co., Ltd.,) as an emulsification apparatus until the volume average particle diameter of the dispersed phase was approximately 10 μm. Polymer fine particles were manufactured in the same operation as in Manufacture Example 1 using this resultant. The volume average particle diameter of the polymer fine particles was 11.2 μm, and the CV value was 36.9%. Tg was not observed.

### Manufacture Example 4 of Polymer Fine Particles

Polymer fine particles were manufactured in the same operation as in Manufacture Example 1 except that a main wire gauze of 165/1400 mesh was used. The volume average particle diameter of the polymer fine particles was 20.6 μm, and the CV value was 21.9%. Tg was not observed.

### Manufacture Example 5 of Polymer Fine Particles

Polymer fine particles were manufactured in the same operation as in Manufacture Example 1 except that the concentration of the cross-linking agent was changed to 5% by mass. The volume average particle diameter of the polymer fine particles was 9.8 μm, and the CV value was 18.9%. Tg was 127° C.

### Manufacture Example 6 of Polymer Fine Particles

Polymer fine particles were manufactured in the same operation as in Manufacture Example 1 except that the cross-linking agent concentration was changed to 10% by mass. The volume average particle diameter of the polymer fine particles was 9.8 μm, and the CV value was 18.7%.

Tg was 139° C.

### (Manufacture of Master Batch)

The following polymer fine particles were used as the AB agent:

Example 1: Polymer fine particles obtained in Manufacture Example 1
Example 2: Polymer fine particles obtained in Manufacture Example 2
Example 3: Polymer fine particles obtained in Manufacture Example 3
Example 4: Polymer fine particles obtained in Manufacture Example 4

### Comparative Example 1: Polymer Fine Particles Obtained in Manufacture Example 5

### Comparative Example 2: Polymer Fine Particles Obtained in Manufacture Example 6

LLDPE (UF641) available from Japan Polyethylene Corporation was used as a polyolefin resin.

90% by mass of the polyolefin resin pellet and 10% by mass of the AB agent described above were dry-blended, and a small-sized twin screw extruder (HK25D testing machinery manufactured by Parker Corporation, Inc.,) was used under the conditions of temperatures at an inlet, a screw portion, a mesh portion, and a die outlet of 61° C., 200° C., 190° C., and 180° C., respectively, and a strand diameter φ of 5 mm, to manufacture master batch pellets.

The die outlet portion was observed, and die build-up generation onset time (minute) elapsed until the die build-up was generated from the starting end of a strand was measured. After 20 minutes, the generation of die build-up was not found in Examples 1 to 4. On the other hands, in Comparative Examples 1 and 2, immediately after starting the formation of a strand, the generation of die build-up like white powder was found around the die outlet portion. The amount of the die build-up was increased with time. Three minutes after the starting, the die build-up was grown and became very big.

The results are shown in Table 1 together.

### Example 5

Master batch pellets were manufactured in the same manner as in Example 1 except that the fine particles obtained in Manufacture Example 1 as an AB agent were used and the polyolefin resin pellets and the AB agent were changed to 70% by mass and 30% by mass, respectively. The die outlet portion was observed, and die build-up generation onset time (minute) elapsed until die build-up was generated from the starting end of a strand was measured. After 20 minutes, the generation of die build-up was not found. The results are shown in Table 1.

### Example 6

Master batch pellets were manufactured in the same manner as in Example 1 except that the fine particles obtained in Manufacture Example 1 as an AB agent were used and the polyolefin resin pellets and the AB agent were changed to 60% by mass and 40% by mass, respectively. The die outlet portion was observed, and die build-up generation onset time (minute) elapsed until the die build-up was generated from the starting end of a strand was measured. After 20 minutes, the generation of die build-up was not found. The results are shown in Table 1.

### Example 7

The fine particles obtained in Manufacture Example 1 and LLDPE (UF641) available from Japan Polyethylene Corporation were used as an AB agent and a polyolefin resin, respectively. 400 kg (80% by mass) of the polyolefin resin pellet and 100 kg (20% by mass) of the AB agent were dry-blended with a Henschel Mixer, and a twin screw extruder (corresponding to real machine, die diameter: 5 mm, hole number: 13) was used under the conditions of temperatures at an inlet, a screw portion, a mesh portion, and a die outlet of 180° C., 200° C., 190° C., and 180° C., respectively, to manufacture master batch pellets.

The die outlet portion was observed, and die build-up generation onset time (minute) until the die build-up was generated from the starting end of a strand was measured. After 50 minutes, the generation of die build-up was not found. The results are shown in Table 1.

TABLE 1

| | | | | | MASTER | |
|---|---|---|---|---|---|---|
| | POLYMER FINE PARTICLE (AB AGENT) | | | | BATCH | DIE BUILD- |
| | | AVERAGE | | | BLENDED | UP |
| | CROSS-LINKING AGENT | PARTICLE | | | RATIO OF AB | GENERATION |
| | CONCENTRATION | DIAMETER | CV VALUE | Tg | AGENT | ONSET |
| | (% BY MASS) | (μm) | (%) | (° C.) | (% BY MASS) | TIME |
| EXAMPLE 1 | 20 | 10.1 | 17.7 | — | 10 | 20 min< |
| EXAMPLE 2 | 30 | 10.1 | 18.5 | — | 10 | 20 min< |
| EXAMPLE 3 | 20 | 11.2 | 36.9 | — | 10 | 20 min< |
| EXAMPLE 4 | 20 | 20.6 | 21.9 | — | 10 | 20 min< |
| COMPARATIVE | 5 | 9.8 | 18.9 | 127 | 10 | <1 min |
| EXAMPLE 1 | | | | | | |
| COMPARATIVE | 10 | 9.8 | 18.7 | 139 | 10 | <1 min |
| EXAMPLE 2 | | | | | | |
| EXAMPLE 5 | 20 | 10.1 | 17.7 | — | 30 | 20 min< |
| EXAMPLE 6 | 20 | 10.1 | 17.7 | — | 40 | 20 min< |
| EXAMPLE 7 | 20 | 10.1 | 17.7 | — | 20 | 50 min< |

—: Tg not observed

As seen from Table 1, in the polymer fine particles (AB agent) of Examples 1 to 7, Tg was not observed. Therefore, it was confirmed that the effect of the cross-linking agent was exerted. Further, in Examples 1 to 7, the generation of die build-up was not found for 20 minutes or longer during the manufacture of AB agent master batch. Therefore, the effect on preventing the generation of die build-up was confirmed. On the contrary, in Comparative Examples 1 and 2, in which the concentration of the cross-linking agent is low, Tg was observed. In addition, the generation of die build-up like white powder was found around the die outlet portion immediately after starting the formation of an extruded strand during the manufacture of the AB agent master batch. Therefore, the effects on preventing the generation of die build-up were not confirmed.

### (Manufacture of Two-Layered Film)

LLDPE (NC564A) available from Japan Polyethylene Corporation was used as a polyolefin resin. The LLDPE was used as a base layer, and as a sealant layer, the anti-blocking agent master batch in Example 1 and the LLDPE as a base resin were mixed in a proportion shown Table 2 and they were melt and extruded with a two-layered film extruder to manufacture a two-layered film. The film thickness and the thickness ratio of base layer to sealant layer were set to 50 μm and 4:1, respectively.

TABLE 2

| | | BLENDED AMOUNT OF |
|---|---|---|
| | BLENDED AMOUNT OF | POLYMER FINE PAR- |
| | MASTER BATCH | TICLES (AB AGENT) |
| No. | (PARTS BY MASS) | (PARTS BY MASS) |
| EXAMPLE 8 | 5 | 0.5 (5000 ppm) |
| EXAMPLE 9 | 3 | 0.3 (3000 ppm) |
| EXAMPLE 10 | 1.5 | 0.15 (1500 ppm) |

As the two-layered film extruder, a T-die extruder (manufactured by SOKEN) with a die width of 250 mm and a lip width of 0.1 mm was used to perform extrusion at 210° C., and a film was taken up with cooling roll of 65° C. at a film taking-up speed of 3.5 m/min. The following physical properties of the manufactured films were measured.

(1) Haze: a haze meter manufactured by TOYO SEIKI SEISAKU-SHO, LTD., was used, and the average of five data was calculated.

(2) Gloss: a gloss meter instrument manufactured by NIPPON DENSHOKU INDUSTRIES CO., LTD., was used. The gloss was measured at an incidence angle of 20°, and the average of five data was calculated.

(3) Static friction coefficient: the manufactured sealant layers of two-layered films as described above were brought into contact with each other, and the static friction was measured using a slip tester at a speed of travel of 150 mm/min and a load of 200 g. The average of three data was calculated.

(4) Blocking property: A specimen having a length of 150 mm and a width of 20 mm was cut out from the manufactured two-layered film, and the sealant layers were put together so that the specimens were overlapped by 50 mm in a longitudinal direction to prepare a test sample. The test sample was subjected to a peel test under the following conditions. The average of 8 data was calculated and considered as an intensity for peel of sample.

State adjustment: load of 5 kg, at 60° C. for 5 hours

Speed for peel test: 500 mm/min.

The results are shown in Table 3.

TABLE 3

| | | | STATIC | BLOCKING |
|---|---|---|---|---|
| | HAZE | GLOSS | FRICTION | PROPERTY |
| | (%) | (Gs20°) | COEFFICIENT | (N/10 cm²) |
| EXAMPLE 8 | 3.9 | 122 | 0.835 | 8.5 |
| EXAMPLE 9 | 3.7 | 126 | 0.885 | 9.4 |
| EXAMPLE 10 | 3.6 | 115 | 1.533 | 9.9 |

As seen from Table 3, as the blended amount of AB agent is increased in order of Examples 10, 9, and 8, although haze of the two-layered film is slightly increased, the static friction coefficient is decreased and blocking resistance is improved. The effect on preventing the blocking of AB agent was confirmed.

### INDUSTRIAL APPLICABILITY

In the polymer fine particles of the present invention, die build-up is not generated around the outlet of an extruder during the manufacture of a master batch. Therefore, when the polymer fine particles are diluted with polyolefin resin to adjust an AB agent to an appropriate content, and the particles are added during the manufacture of a film, a film superior in blocking resistance can be obtained. This film can be used for the manufacture of various packaging materials and high quality products as industrial materials.

What is claimed is:

1. An organic polymer fine particle, comprising a polyfunctional monomer (cross-linking agent) having at least one kind of two or more functional groups in a monomer unit constituting a polymer, wherein the organic polymer fine particle suppresses generation of die build-up around an outlet of an extruder when the polymer fine particles are mixed and kneaded with a polyolefin resin using the extruder to manufacture a master batch.

2. The organic polymer fine particle according to claim 1, wherein the polymer fine particle is prepared by polymerizing any of an acryl-based monomer or a styrene-based monomer, or any monomer of vinyl acetate, vinyl chloride, vinylidene chloride, acrylonitrile, methacrylonitrile, or a combination of the above-described monomer or monomers and other monomer or monomers.

3. The organic polymer fine particle according to claim 1, wherein the polymer fine particles do not have a glass transition temperature (Tg) to be observed by differential scanning calorimetry (DSC).

4. An anti-blocking agent master batch for polyolefin resin, comprising the polymer fine particle according to claim 1 in a blended amount of 1 to 50% by mass.

5. A polyolefin resin film obtained by blending the anti-blocking agent master batch according to claim 4 with a polyolefin resin, and molding the blend.

6. The organic polymer fine particle according to claim 2, wherein the polymer fine particles do not have a glass transition temperature (Tg) to be observed by differential scanning calorimetry (DSC).

7. An anti-blocking agent master batch for polyolefin resin, comprising the polymer fine particle according to claim 2 in a blended amount of 1 to 50% by mass.

8. An anti-blocking agent master batch for polyolefin resin, comprising the polymer fine particle according to claim 3 in a blended amount of 1 to 50% by mass.
